(19) United States
(12) Patent Application Publication
(10) Pub. No.: US 2007/0216908 A1
(43) Pub. Date: Sep. 20, 2007

(54) CLUTTER REJECTION FILTERS FOR OPTICAL DOPPLER TOMOGRAPHY

(75) Inventors: Xingde Li, Seattle, WA (US); Hongwu Ren, Budd Lake, NJ (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 11/688,142

(22) Filed: Mar. 19, 2007

Related U.S. Application Data
(60) Provisional application No. 60/783,555, filed on Mar. 17, 2006.

(51) Int. Cl. G01B 9/02

(52) U.S. Cl. 356/479

(57) ABSTRACT

In Optical Doppler tomography (ODT), or color Doppler optical coherence tomography, the signal component of primary interest arises from moving scatterers, such as flowing blood cells in blood vessels. Clutter rejection filters are provided and used to remove undesired components from the ODT signal, such as clutter induced by stationary scatterers (e.g., the relatively stationary tissue of a blood vessel wall). Empirical results indicate that such clutter rejection filters can be employed to achieve ODT images from which blood vessel diameter can more accurately be estimated than images obtained using conventional ODT techniques. Further, Doppler images obtained using the clutter rejection filter technique disclosed herein exhibit fewer background artifacts induced by the relative motion of stationary scatterers with respect to the scanning probe.

### RELATED APPLICATIONS

This application is based on a prior copending provisional application, Ser. No. 60/783,555, filed on Mar. 17, 2006, the benefit of the filing date of which is hereby claimed under 35 U.S.C. § 119(e).

### GOVERNMENT RIGHTS

This invention was funded at least in part with a grant (No. NIH-1-R21-EB003284-01) from the National Institutes of Health and a grant (No. NSF-BES-0348720) from the National Science Foundation, and the U.S. government may have certain rights in this invention.

### BACKGROUND

Optical coherence tomography (OCT) is an imaging technology that was developed for cross-sectional imaging of scattering media with an axial resolution on the order of a few micrometers, with the actual resolution being determined by the spectral bandwidth of the optical source employed. Optical Doppler tomography (ODT), or color Doppler optical coherence tomography, is an imaging technology that was developed for extracting local flow velocity information along the optical beam axis using the Doppler frequency shift generated from moving scatterers. A phase-resolved ODT (PR-ODT) technique implemented with the autocorrelation of adjacent axial-line (A-line) profiles is widely used to calculate the Doppler frequency shift. Unfortunately PR-ODT suffers from degraded sensitivity due to the relatively small phase change of moving scatterers in the immediate vicinity of stationary scatterers, such as a vessel wall. The vessel size estimated from flow will thus be artificially reduced, and small vessels may be undetectable.

Spectral domain OCT (SD-OCT) is an emerging imaging technology that was developed using principles from spectral interferometry. It has been shown that SD-OCT can perform high sensitivity and high-speed imaging. Recently, the PR technique noted above has been combined with Fourier domain OCT (FD-OCT) to achieve high-speed flow imaging.

The above noted ODT techniques are useful. However, it would be desirable to provide additional ODT imaging techniques that enable better image quality to be achieved, particularly with respect to the disadvantages noted above in regards to PR-ODT.

### SUMMARY

In ODT, the signal component of primary interest arises from moving scatterers, such as flowing blood cells. However, it is likely that the ODT signal will include additional undesired components, such as clutter induced by stationary scatterers (e.g., a blood vessel wall). In broad terms, the concepts disclosed herein relate to characterizing the undesired signal components, so that they can be removed or filtered from the ODT signal, which should improve the ODT image quality. Thus, the concepts disclosed herein can be considered to encompass clutter rejection filters for ODT. In general, such filters can be implemented using hardware- or software-based signal processing, such that the ODT system used to acquire the ODT signal need not be modified beyond the addition of the clutter filtering elements (i.e., the software or hardware required to filter the ODT signal).

The overall steps employed in implementing such a clutter removal method include defining clutter parameters that enable the clutter signal component to be differentiated from the primary signal component of interest (the signal component arising from moving scatterers, such as flowing blood cells), obtaining an ODT signal, generating an image using the ODT signal, filtering the clutter using the defined parameters, generating an ODT image based on the filtered ODT signal, and determining if the filtering has improved the ODT image quality. In at least one exemplary embodiment, the parameter employed to differentiate the clutter signal component from the moving scatterer signal component is a frequency associated with the clutter signal component. The frequency of the clutter signal component can be empirically deduced by obtaining an ODT signal from an area proximate a region of interest, where the ODT signal is likely to include a relatively large clutter component and a relatively small moving scatterer component, and assuming that the predominant frequency in the ODT signal corresponds to the clutter signal component.

Once a clutter rejection filter has been developed, the clutter filtering process involves obtaining an ODT signal from a region of interest and using the filter to remove clutter signal component, leaving the moving scatterer signal component. The filter can be implemented using software-based signal processing, or hardware-based signal processing (e.g., a custom signal processing circuit).

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1A is a flowchart that schematically illustrates an exemplary sequence of logical steps that can be used to generate a clutter rejection filter for ODT imaging;

FIG. 1B is a flowchart that schematically illustrates an exemplary sequence of steps that can be used to filter clutter from ODT signals;

FIG. 2 is a functional block diagram that schematically illustrates filtering clutter from an ODT signal using a single delay line filter (DLF);

FIG. 3 is a functional block diagram that schematically illustrates cascading n simple DLFs, such as that shown in FIG. 2, to construct an n-order DLF;

FIG. 4 is a functional block diagram that schematically illustrates yet another type of n-order DLF, which includes weighting coefficients;

FIG. 5 is a functional block diagram that schematically illustrates a phase-shifted DLF structure;

FIG. 6A graphically illustrates the relationship between a normalized Doppler power spectrum of stationary scatterers and a normalized power transfer function for the first four DLF orders, without implementing the phase shifting of FIG. 5;

FIG. 6B graphically illustrates the relationship between a normalized Doppler power spectrum of the stationary scatterers and a normalized power transfer function for the first four DLF orders, with implementing the phase shifting of FIG. 5;

FIG. 7 schematically illustrates a high-speed SD-OCT system that can be used to implement both the conventional PR-ODT technique and the novel “moving scatterer sensitive ODT” (MSS-ODT) technique disclosed herein;

FIG. 8 is a functional block diagram schematically illustrating exemplary processing for both the conventional PR-ODT technique, and the MSS-ODT technique disclosed herein;

FIGS. 9A and 9B are, respectively, positive and negative greyscale Doppler flow images of a capillary tube in a gel phantom, obtained using the exemplary system of FIG. 7 and the conventional PR-ODT technique;

FIGS. 10A and 10B are, respectively, positive and negative greyscale Doppler flow images of a capillary tube in a gel phantom, obtained using the exemplary system of FIG. 7 and the MSS-ODT technique disclosed herein;

FIG. 11 schematically compares the relative sizes of the inner diameter of the capillary tube as measured using imagery from both the conventional PR-ODT technique and the MSS-DOT technique disclosed herein, illustrating that the MSS-ODT technique provides a more accurate estimation of the actual inner diameter of the capillary tube;

FIGS. 12A and 12B are, respectively, positive and negative structural images of the capillary tube/gel phantom structure;

FIG. 12C graphically illustrates experimental flow profiles obtained using MSS-ODT and PR-ODT;

FIGS. 13A and 13B are, respectively, positive and negative greyscale Doppler flow images of blood vessels in a mouse ear, obtained using the exemplary system of FIG. 7 and the conventional PR-ODT technique;

FIGS. 14A and 14B are, respectively, positive and negative greyscale Doppler flow images of blood vessels in a mouse ear, obtained using the exemplary system of FIG. 7 and the MSS-ODT technique disclosed herein;

FIGS. 15A and 15B are, respectively, positive and negative structural images of blood vessels in a mouse ear;

FIG. 15C graphically illustrates experimental flow profiles obtained using MSS-ODT and PR-ODT;

FIG. 16 is a functional block diagram schematically illustrating exemplary clutter rejection processing in the time domain; and

FIG. 17 is a functional block diagram schematically illustrating exemplary clutter rejection processing in the spectral domain.

### DESCRIPTION

### Figures and Disclosed Embodiments Are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

ODT systems are most often used to acquire data and image blood flow in biological systems, and the concepts disclosed herein are discussed in terms of such biological systems, where moving scatterers are assumed to be blood cells in flow, and stationary scatterers are assumed to be tissue associated with walls of blood vessels. It should be recognized however, that the concepts disclosed herein can be applied to differentiate between other types of moving and stationary scatterers, thus the concepts disclosed herein are not limited to the use of ODT in analyzing blood flow in biological systems.

As noted above, in most ODT systems, the autocorrelation method is used to estimate the Doppler flow velocity from the sequential axial line (A-line) signal (the PR-ODT technique noted in the Background of the Invention). However, such a PR-ODT signal likely includes both a signal component corresponding to clutter, and a signal component corresponding to moving scatterers (the signal component of interest). The concepts disclosed herein encompass a clutter rejection filter that is designed to separate out the clutter signal component from the moving scatterers signal component. The clutter signal component is likely a stationary signal component induced by stationary scatterers, such as tissue forming the blood vessel wall. The moving scatterers signal component is generally induced by moving scatterers, such as flowing blood cells in tissues. Particularly where the region of interest is close to a blood vessel wall, the moving scatterers signal component is likely to be relatively small (fewer and slower moving blood cells will be found adjacent to the blood vessel wall, as compared to a core of the blood vessel), hence removal of the clutter signal component can significantly improve the quality of the data acquired, and a quality of images generated using the acquired data.

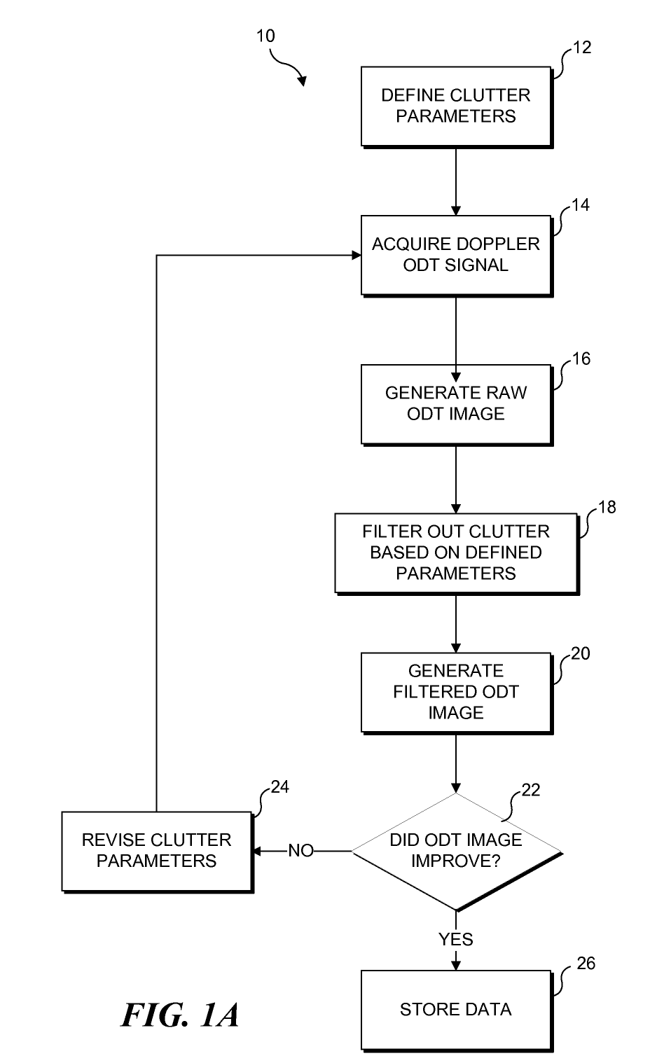

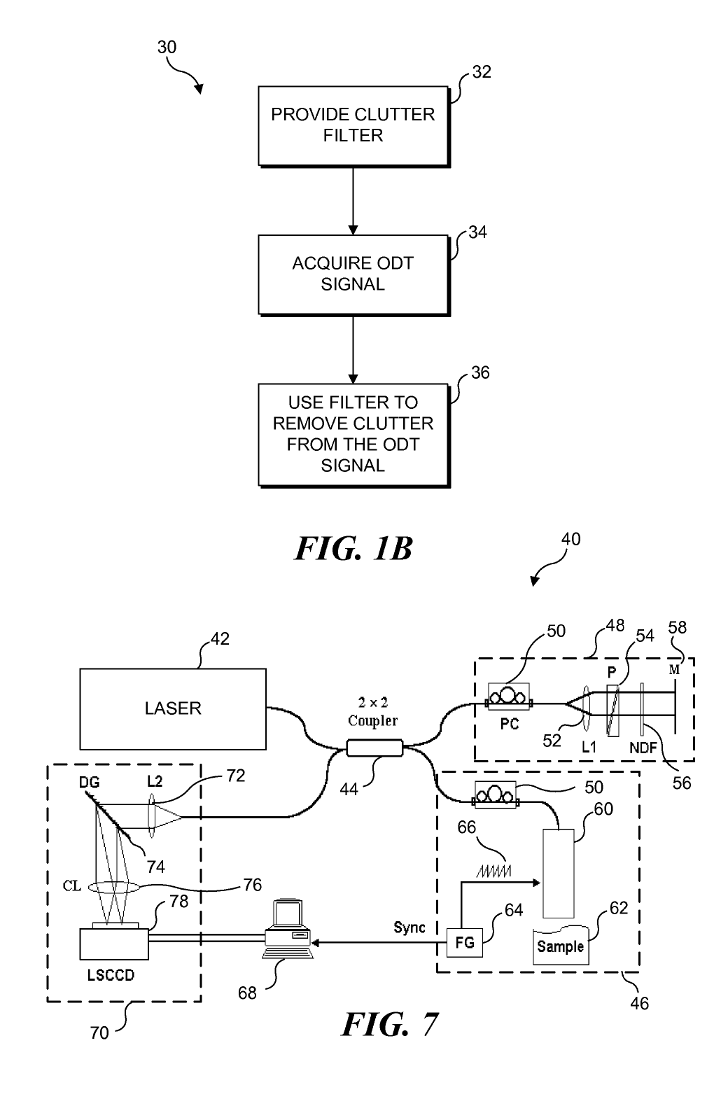

FIG. 1A is a flowchart 10 that schematically illustrates an exemplary sequence of logical steps that can be used to generate a clutter rejection filter for ODT imagining. In a first step represented by a block 12, clutter parameters (i.e., at least one parameter that can be used to differentiate a clutter signal component from a signal component of interest, such as the moving scatterer signal component) are defined. In another step, indicated by a block 14, the ODT signal (including both a clutter signal component and a moving scatterer signal component) is acquired. In another step, indicated by a block 16, a first image (i.e., a raw, unfiltered ODT image) is generated from the unfiltered ODT data. In a subsequent step, indicated by a block 18, the defined parameters are used to remove clutter from the ODT signal. In a following step, indicated by a block 20, a second image (i.e., a filtered image) is generated using the filtered ODT signal. The images generated from the filtered and unfiltered ODT signal are compared, as indicated by a decision block 22. If the filtering resulted in an improved image, the data (the parameters used to perform the filtering, and if desired, the filtered ODT signal) are stored, as indicated by a block 26. If the filtered image is not improved, or the improvement is not acceptable, then the clutter parameters are revised to develop a new clutter filter, as indicated in a block 24. The revised clutter filter is then tested, as indicated by the loop back to block 14.

In at least one exemplary embodiment, at least one clutter parameter is a frequency associated with the clutter signal component. The frequency of the clutter signal component can be empirically deduced by obtaining an ODT signal from an area proximate a region of interest, where the ODT signal is likely to include a relatively large clutter component and a relatively small moving scatterer component, and assuming that the predominant frequency in the ODT signal corresponds to the clutter signal component. The sequence of steps illustrated in FIG. 1A can then be used to determine the effectiveness of the deduced frequency as a clutter rejection parameter.

Once a useful clutter filter has been developed, a flowchart 30 shown in FIG. 1B illustrates an exemplary sequence of steps that can be used to filter ODT signals. In a block 32 a clutter filter is provided, while in a block 34 an ODT signal is acquired. In a block 36, the provided clutter filter is used to remove clutter from the ODT signal. It should be recognized that the steps in flowchart 30 can be implemented by software (i.e., machine instructions executed by a processor), or by hardware (e.g., a custom signal processing circuit).

Having broadly described techniques for generating and using clutter rejection filters in ODT imaging, detailed exemplary implementations will now be described.

As noted above, in the conventional PR-ODT technique, the autocorrelation method is used to estimate the Doppler flow velocity from the sequential axial line (A-line) signal. Such filters can be implemented in either the time domain or the Fourier domain (including the spectral domain, as well as the swept-source OCT). The objective of clutter rejection techniques is to minimize the influence of clutter on the Doppler flow signal and improve the sensitivity of Doppler flow estimation algorithms in regard to moving scatterers.

With respect to the time domain, clutter rejection can be realized in time domain using a simple delay line filter (DLF). With respect to the spectral domain (or Fourier domain in general), in one aspect of the concepts disclosed herein as implemented using an exemplary embodiment, clutter rejection filtering is first applied to the A-line signals, and a conventional velocity estimator based on adjacent A-line autocorrelation can then be used to extract the Doppler frequency shift originated from moving scatterers. This operation is different from PR-ODT, which directly employs the autocorrelation velocity estimator without clutter rejection.

Thus, in one exemplary embodiment, a DLF is used before the Doppler frequency shift estimation implemented in the PR-ODT method. As discussed in greater detail below, empirical ODT images obtained with and without delay line filtering indicate that delay line filtering can be employed as a clutter rejection filter for ODT imaging. The term “moving scatterer sensitive ODT” (MSS-ODT) has been coined to refer to this delay line filtering PR-ODT technique. Note that the conventional PR-ODT technique employs only a velocity estimator, but not a clutter rejection filter and velocity estimation.

Thus, in at least one exemplary embodiment, a phase-shifted DLF is used as the clutter rejection filter. The DLF is employed to filter the A-line signal before a velocity estimator is used to extract Doppler frequency shift of the reflected signal. In an empirical study, the frequency response of different orders of DLFs were analyzed theoretically to prove that the DLF filter technique can be used to separate out the clutter signal component (a primary cause of clutter is the stationary signal component induced by stationary scatterers, such as the blood vessel wall) from the Doppler signal component (induced by moving scatterers, such as flowing blood cells in tissue). Empirical studies and images of fluid flow in capillary tubes and in vivo blood flow in mouse ears have shown that MSS-ODT offers clear advantages compared to conventional PR-ODT (i.e., Doppler ODT without clutter filtering). In such studies, the phase-shifted DLF was implemented in an SD-OCT system. The A-line scan rate of the SD-OCT system employed in the empirical studies was 12.3 k lines/s, allowing real-time structural and Doppler flow imaging to be achieved. Doppler flow images obtained by using a DLF clutter rejection filter with an autocorrelation velocity estimator are compared to those obtained by prior Doppler OCT techniques (i.e., PR-ODT with an autocorrelation velocity estimator but no clutter rejection filtering) to investigate the improvement DLF provided for Doppler flow imaging. Such empirical studies indicate that the accuracy of Doppler flow estimation is improved when a clutter filter is employed, especially when the region of interest is near the wall of a blood vessel. When a clutter rejection filter is employed, the size of blood vessels can be more accurately determined, and small blood vessels that might be masked by stationary scatterers using conventional PR-ODT (i.e., PR-ODT with an autocorrelation velocity estimator but no clutter rejection filtering) can be successfully imaged. Such clutter rejection filters can be beneficially employed for imaging in vivo blood flow in human tissues, especially retinal blood flow.

A key principle in the clutter rejection filter concepts disclosed herein is that the signal back-reflected from stationary scatterers is rejected, to improve the Doppler flow imaging of moving scatterers. As noted above, such clutter rejection filters can be realized using a simple time domain DLF. Thus, the MSS-ODT technique disclosed herein combines the clutter rejection filter and the PR velocity estimator, while conventional PR-ODT uses only the PR velocity estimator for Doppler flow imaging.

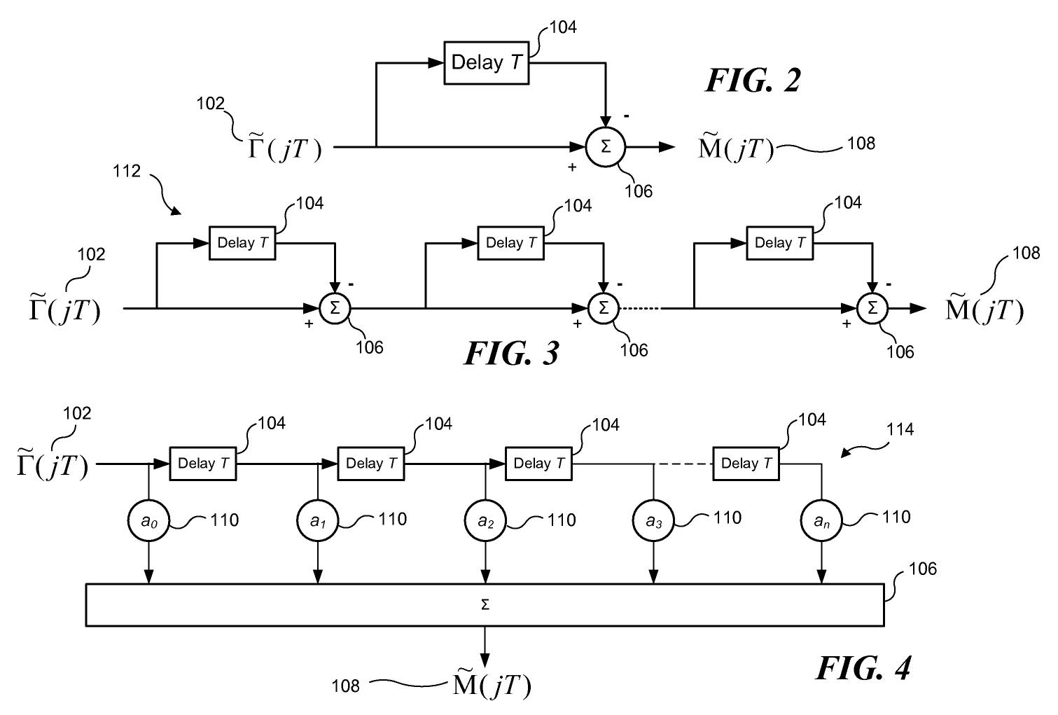

The Doppler frequency shift can be used to separate the desired moving scatterers (such as blood cells) from stationary or undesired slowly moving scatterers (such as vessel walls). The Doppler spectrum separation can be realized using a single DLF shown in the diagram of FIG. 2, in which: \tilde{Γ}(jT) is an input 102 (i.e., the j^{th} complex analytical A-line fringes) of a delay line filter 104; T is the A-line repetition period; Σ denotes a sum operation 106; and \tilde{M}(jT) is an output 108 of the single DLF. \tilde{Γ}(jT) is the complex analytical depth profile obtained from the jₜₕ A-line fringe; T is equal to the inverse of the A-line scan rate ƒᵣ of an OCT system; and \tilde{M}(jT) can be calculated using the following relationship:
\tilde{M}(jT)=\tilde{Γ}(jT)−\tilde{Γ}(jT−T). (1)

Setting t=jT, the impulse response h(t) of the filter of Eq. (1) is provided by the following relationship:
h(t)=δ(t)−δ(t−T), (2)
where δ is the delta function. The output \tilde{M}(jT) is the convolution between \tilde{Γ}(jT) and the impulse response. Fourier transformation of h(t) yields the frequency response H(ƒ) of the filter in Doppler frequency shift (ƒ) domain, as indicated by the following relationship:
H(ƒ)=1−exp(−i2πƒT), (3)
in which i is the complex number unit.

The output Doppler spectrum is the product of the frequency response of the filter and the input Doppler spectrum, as described by the following relationship:
\tilde{M}(ƒ)=\tilde{Γ}(ƒ)H(ƒ). (4)

From Eq. (3), the power transfer function of the DLF can be determined using the following relationship:
|H(ƒ)|²=4 sin²(πƒT). (5)

From Eq. (4), the Doppler power spectrum of the output is also the product of the power transfer function and the Doppler power spectrum of the input. Letting z=exp(i2πƒT), then Eq. (3) is transformed in the z-domain, as described by the following relationship:
H(z)=1−z⁻¹. (6)

As indicated in the diagram of FIG. 3, n such simple DLFs 104 can be cascaded to construct an n-order DLF 112. Eq. (6) indicates that the frequency response of the n-order DLF can be defined using the following relationship:

$$H ( z ) = {( 1 - {z}^{- 1} )}^{n} = {\sum }_{k = 0}^{n} {a}_{k} {z}^{- k} \qquad ( 7 )$$

where aₖ is the binomial coefficients that can be obtained from the following relationship:

$${a}_{k} = {( - 1 )}^{k} \frac{n !}{( n - k ) ! k !} \qquad ( 8 )$$

From Eq. (7) and the z transform property (D. Schlichtharle, Digital Filters: Basics and Designs (Springer-Verlag, 2000)), the n-order DLF can be formulated as an equivalent filter structure 114 as shown in the diagram of FIG. 4. The weighting coefficients 110 (i.e., a₀ to aₙ) in the diagram of FIG. 4 are the same as the binomial coefficients in Eq. (8). The power transfer function of the two types of n-order DLF structures (i.e., the diagrams of FIGS. 3 and 4) is provided by the following relationship:
|H(ƒ)|²=[4 sin²(πƒT)]ⁿ. (9)

For all practical purposes, the displacement scanned across samples by the lateral scanning probe should be less than the spot size of the light beam in the samples, to ensure the successive A-line fringes are correlated. Thus, only a few A-line scanning intervels and low order DLFs are necessary for ODT applications. Exemplary weighting coefficients for the first four DLFs can be calculated from Eq. (8), and are listed in Table 1 for reference. From Eq. (9), it can be determined that the stop bands fₛₜₒₚ of these filters are described by fₛₜₒₚ=mfᵣ, where m is an integer and fᵣ is the A-line scan rate. These stop bands introduce the blind Doppler frequency of these filters, in which the system provides a null Doppler frequency shift. When the relative motion of the stationary scatters with respect to the lateral scanning probe is so small that the Doppler frequency shift induced falls within the stop-band of the DLF used, then the back-reflection signal induced by stationary scatterers is separated out, and its influence on the estimation of Doppler frequency shift is greatly reduced. In contrast, if the stationary scatters were not properly suppressed by the DLF, then Doppler flow information cannot be properly extracted by the velocity estimator.

TABLE 1
Weighting Coefficients of the First Four Delay Line Filters

| Delay Line | A-line | | | | | |
|---|---|---|---|---|---|---|
| Numbers | Numbers | a₀ | a₁ | a₂ | a₃ | a₄ |
| 1 | 2 | 1 | −1 | | | |
| 2 | 3 | 1 | −2 | 1 | | |
| 3 | 4 | 1 | −3 | 3 | −1 | |
| 4 | 5 | 1 | −4 | 6 | −4 | 1 |

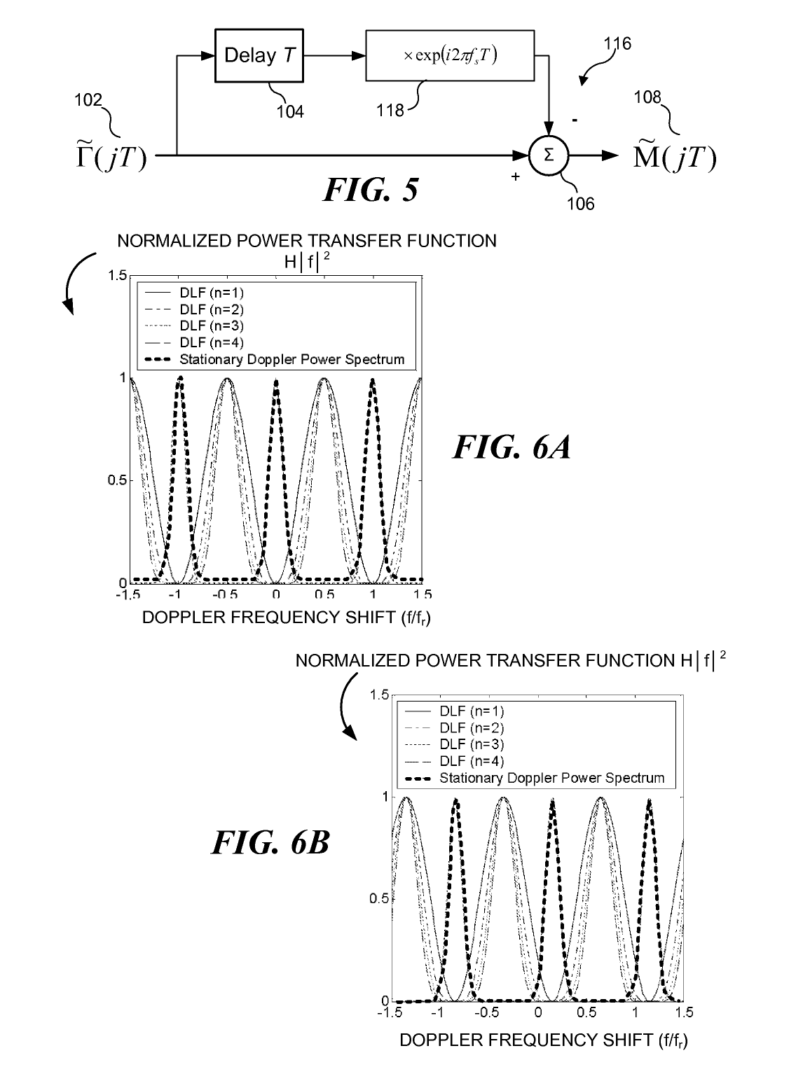

Referring once again to the lateral scanning probe of an OCT system configured for ODT imaging, if the probe moves relative to the stationary scatterers with a Doppler angle other than 90 degrees, the Doppler frequency shift resulting from the stationary scatterers will not be zero, and therefore a phase shift is required to shift the stop band frequency to match the Doppler frequency shift of these stationary scatterers. To accomplish this, the DLF described above with respect to the diagrams of FIG. 2 can be replaced with a phase-shifted DLF structure 116, as shown in the diagram of FIG. 5, where a phase-shift of 2πƒₛT matched to the Doppler frequency shift of the stationary scatterers ƒₛ is multiplied with the delayed A-line signal in the delay branch, by coupling a phase shifting function 118 to DLF 104. Typically ƒₛ=ηƒᵣ, where η is a fractional number, and the A-line scanning rate is ƒᵣ=1/T. Defining β=exp(−i 2πƒₛT) and using Eq. (7), the frequency response of n-order phase-shifted DLF is provided by the following relationship:

$$H ( z ) = {[ 1 - {( β z )}^{- 1} ]}^{n} = {\sum }_{k = 0}^{n} {{a}_{k} ( β z )}^{- k} . \qquad ( 10 )$$

The power transfer function of the phase shift filter of FIG. 6 is provided by the following relationship:
|H(ƒ)|²={4 sin² [π(ƒ−ƒₛ)T]}ⁿ. (11)

The Doppler power spectrum of stationary scatterers introduced by its relative motion with respect to the scanning probe can be described by the following Gaussian function:

$$S ( f ) = \frac{1}{\sqrt{2 π} {σ}_{f}} exp [ - \frac{{( f - {f}_{s} )}^{2}}{2 {σ}_{f}^{2}} ] \qquad ( 12 )$$

where ƒₛ denotes the Doppler frequency shift of the stationary scatterers, and σ_{f} is the Doppler bandwidth of the stationary scatterers. The Doppler power spectrum of the stationary scatterers is folded in the Doppler frequency shift domain due to the 2π ambiguity phenomena of the frequency shift estimation, thereby influencing the estimation of the Doppler frequency shift of the moving scatterers.

The normalized Doppler power spectrum S(ƒ) of the stationary scatterers and the normalized power transfer functions |H(ƒ)|² of the first four orders without and with phase-shifting are respectively illustrated in FIGS. 6A and 6B. The Doppler bandwidth σ_{f} is set to 0.1ƒᵣ assuming the width of temporal correlation window to be 10 A-line intervals (i.e., 10T). The Doppler bandwidth σ_{f} of the stationary scatterers is set to be 0.1ƒᵣ for both cases. The frequency shift of the Doppler bandwidth is set to be 0 for FIG. 6A (no phase shifting) and 0.17ƒᵣ for FIG. 6B (phase shifting).

In FIG. 6B, the stop bands fₛₜₒₚ of the DLFs with a phase shift of 2πƒₛT can be described by the equation ƒₛₜₒₚ=mƒᵣ+ƒₛ, with their values shifted by an amount ƒₛ to match the Doppler frequency shift of the stationary scatterers. Therefore, the phase-shifted DLF can suppress the influence of stationary scatterers on the estimation of the Doppler flow information of moving scatterers.

From the theoretical discussions provided above, it follows that the MSS-ODT (clutter filtering combined with phase-resolved autocorrelation of adjacent A-line profiles) technique disclosed herein is independent of the OCT system used for imaging. The conventional PR-ODT technique (phase-resolved autocorrelation of adjacent A-line profiles without clutter filtering) is also independent of the OCT system used for imaging. Therefore, both techniques can be implemented in both time and Fourier domain OCT systems , where the systems are capable of generating complex analytical A-line fringes.

The MSS-ODT technique disclosed herein was empirically implemented using a fiber-optically based SD-OCT system 40, as shown in FIG. 7. System 40 employs a Kerr-lens mode-locked Ti:sapphire laser light source 42, having a center wavelength of 825 nm, and a full width at half maximum (FWHM) bandwidth of 150 nm. A 2×2 fiber coupler 44 is used to split the light from light source 42 into a sample arm 46 and a reference arm 48. Each of these arms includes a polarization controller 50. In reference arm 48, a lens 52 directs the light to a prism pair 54, which is used to compensate for dispersion. Following the prism pair is an adjustable neutral density filter 56, which is used to attenuate the light. Transverse scanning in the sample arm is achieved by driving a galvanometer (not separately shown) in a handheld probe 60, disposed proximate a sample 62, with a function generator 64 (it should be noted that the function generator need not be considered to be part of the sample arm, as long as the function generator is operatively coupled with the sample probe). Light back-reflected from the sample and reference arms is combined by a Michelson interferometer and is sent to an imaging spectrometer 70, which detects the spectral interference fringes. Imaging spectrometer 70 includes a collimating lens 72 (f=10 cm), a transmission diffraction grating 74 (1200 lines/mm), a chromatic focusing lens 76 (f=50 cm), and a fast line-scan charge coupled device (CCD) camera 78 (2048 pixels, 14×14 μm). The total A-line acquisition time, T, including signal integration (75 μs), digitization, and data readout, was ˜81 μs. The integration time was experimentally determined to balance signal-to-noise ratio against fringe washout due to the system mechanical instability and image target motion. Digitized spectral fringe profiles from the camera were acquired by a frame grabber card (not separately shown) and transferred to a computer 68 at a rate of 12.3 k lines per second for further signal processing. The data acquisition and transfer were triggered by a signal synchronized with a ramp function that drove the lateral scanning galvanometer. The imaging frame rate was about 6.15 frames per second, given each frame of 2000 A-lines. The axial resolution of this system is 2.5 μm in air, and its dynamic range is about 106 dB. The power incident on the sample surface is about 3 mW.

It should be recognized that system 40 is exemplary, and the techniques disclosed herein can be used with other ODT imaging systems.

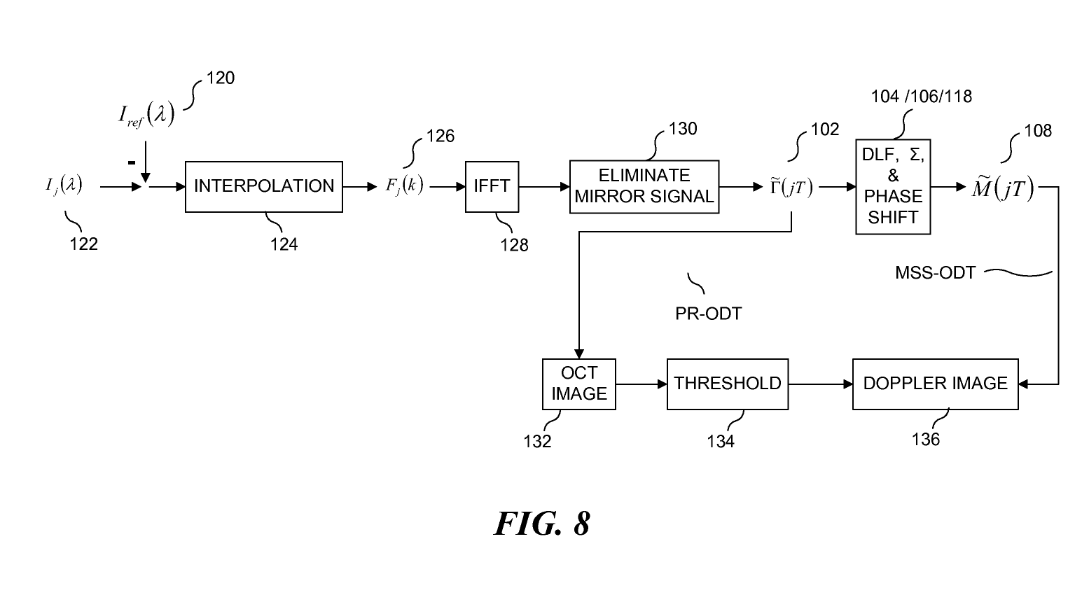

An exemplary signal processing process for extracting the Doppler flow image from SD-OCT system 40 is schematically illustrated in the diagram of FIG. 8. Note FIG. 8 schematically illustrates exemplary processing steps for both the conventional PR-ODT technique, and the MSS-ODT technique disclosed herein. For traditional PR-ODT, only two main steps are needed to obtain the Doppler flow information. In a first main step, input 102 (i.e., the j^{th} complex analytical A-line fringes; \tilde{Γ}(jT)) is reconstructed from A-line spectral fringes. The input is reconstructed by first subtracting a spectrum intensity 120 (I_{ref}(λ)) of the reference arm (that is detected with the sample arm being blocked) from a spectral interference fringe 122 (Iⱼ(λ)), to remove the DC term of the spectrum. Then, the result is re-sampled to yield a uniform spectrum 126 (Fⱼ(k)) in the wave number (k=2π/λ) domain, using a spline interpolation algorithm 124. Next, input 102 (i.e., the j^{th} complex analytical A-line fringes; \tilde{Γ}(jT)), is obtained by performing an inverse Fourier transformation 128 on uniform spectrum 126 (Fⱼ(k)), and eliminating the redundant mirror signal as indicated by a block 130. The second main step is to retrieve the local Doppler frequency shift, using the phase-resolved method (i.e., PR-ODT). In such a process, an OCT image 132 undergoes a thresholding process as indicated by a block 134, yielding a Doppler image 136.

For the MSS-ODT technique, an extra step is required; a phase-shifted DLF 104/106/118 (see FIG. 5) is applied to input 102 (i.e., the j^{th} complex analytical A-line fringes; \tilde{Γ}(jT)) before the velocity estimation is performed. Based on the analysis provided above, use of the DFL should provide increased sensitivity with respect to flow detection. The Doppler frequency shift, ƒ(m, n), at pixel (m, n) is calculated from output 108 of the phase-shifted DLF, \tilde{M}(jT), using the following relationship:

$$\begin{matrix}f ( m , n ) = \frac{1}{2 π T} {tan}^{- 1} ( \frac{Im [ V ]}{Re [ V ]} ) , \\ where & ( 13 a ) \\ V = {\sum }_{z = p ( m - 1 )}^{p ( m - 1 ) + S} {\sum }_{j = q ( n - 1 )}^{q ( n - 1 ) + K} {\tilde{M}}_{z} ( j T ) {\tilde{M}}_{z}^{*} ( j T + T ) , & ( 13 b )\end{matrix}$$

and where p and q are shift steps along the axial (z) direction and lateral scanning (jT) direction. The above calculation is performed within a two-dimensional window of a size S×K, where S is the height of the averaging window along direction z, and K is the number of A-lines that the window spans along the lateral scanning (jT) direction. \tilde{M}_{z}*(jT+T) denotes the conjugate of \tilde{M}_{z}(jT+T). The unambiguous dynamic range of the frequency shift for Doppler flow imaging is [−1/(2T), 1/(2T)], which is about [−6.2, 6.2] kHz, given T=81 μs, as used for the empirical studies disclosed herein. Because pixels with low intensity will be quite sensitive to noise, the Doppler frequency shift at a given pixel is set to zero when its intensity value is smaller than a preset threshold. In practice the threshold is typically set about 15 dB higher than the average noise level of the structural image, and the same threshold criterion is applied in both PR-ODT and MSS-ODT techniques. This thresholding operation helps alleviate the influence of noise on the Doppler flow image.

To summarize, Eq. (1) is the realization of a single delay line filter in the lateral (temporal) direction as a simple finite difference operation. The frequency response in Doppler frequency shift ƒ domain can be obtained by taking Fourier transform of both sides of Eq. (1). The Doppler power spectra in the ƒ-domain, M(ƒ) and Γ(ƒ) are related by M(ƒ)=|H(ƒ)|²Γ(ƒ), where |H(ƒ)|² is a power transfer function taking the form of |H(ƒ)|²=4 sin²(πƒT) From the spectral response |H(ƒ)|² of this simple delay line filter, it is apparent that signals with Doppler frequency shifts near zero (corresponding to stationary scatterers) will be suppressed, but Doppler frequency shifts away from zero (corresponding to moving scatterers) will survive. Therefore, using the filtered quantity \tilde{M}ⱼ(z) reduces contributions from stationary scatterers and improves sensitivity to nearby moving scatterers in the estimation of Doppler frequency shift.

It should be recognized that clutter filtering can be implemented using a variety of different filtering paradigms. As briefly discussed in the Summary section above, correlating a specific frequency with clutter enables a simple clutter filter to be developed. As discussed in detail above, signal processing in the spectral domain using delay line filtering can be employed. A related time domain filtering paradigm is discussed below. These different filtering paradigms can be implemented in many different ways. Because of the ubiquitous nature of personal computers (and because most OCT systems are used in conjunction with a personal computer for signal processing), in one exemplary embodiment, the clutter rejection filters are implemented as machine instructions executed by a computer processor. However, custom signal processing circuits, such as application specific integrated circuits (ASICs), could alternatively be employed.

In order to evaluate the MSS-ODT technique disclosed herein with the conventional PR-ODT technique, both MSS-ODT and PR-ODT images were obtained. The empirical MSS-ODT images were obtained using a first order phase-shifted DLF. The PR-ODT images were obtained without stationary scatterers being filtered out from the complex analytical fringes. Each set of images were obtained using SD-OCT system 40 with the same intensity threshold, and the averaging window size of 4 μm wide by 2.4 μm deep (i.e., N=4, and K=4 in Eq. (13a)).

One advantage the MSS-ODT technique offers over the conventional PR-ODT technique is that the MSS-ODT technique provides improved accuracy in vessel size measurement. This advantage was empirically demonstrated using a flow phantom experiment, where the phantom was made of gelatin mixed with TiO₂ granules (1 mg/ml), to provide tissue-mimicking background scattering. A capillary tube (inner diameter=75 μm) with a 2% Intralipid solution flowing therethrough was embedded within the phantom. The tube was slightly tilted with respect to the phantom surface to ensure a non-zero Doppler angle, and the flow rate was controlled by a syringe pump. The spectral interference fringes detected from the SD-OCT system were analyzed using both the conventional PR-ODT technique and the MSS-ODT technique. The factor η of the phase-shifted DLF was defined as 0.2 for this phantom experiment, based on values employed in previous empirical studies.

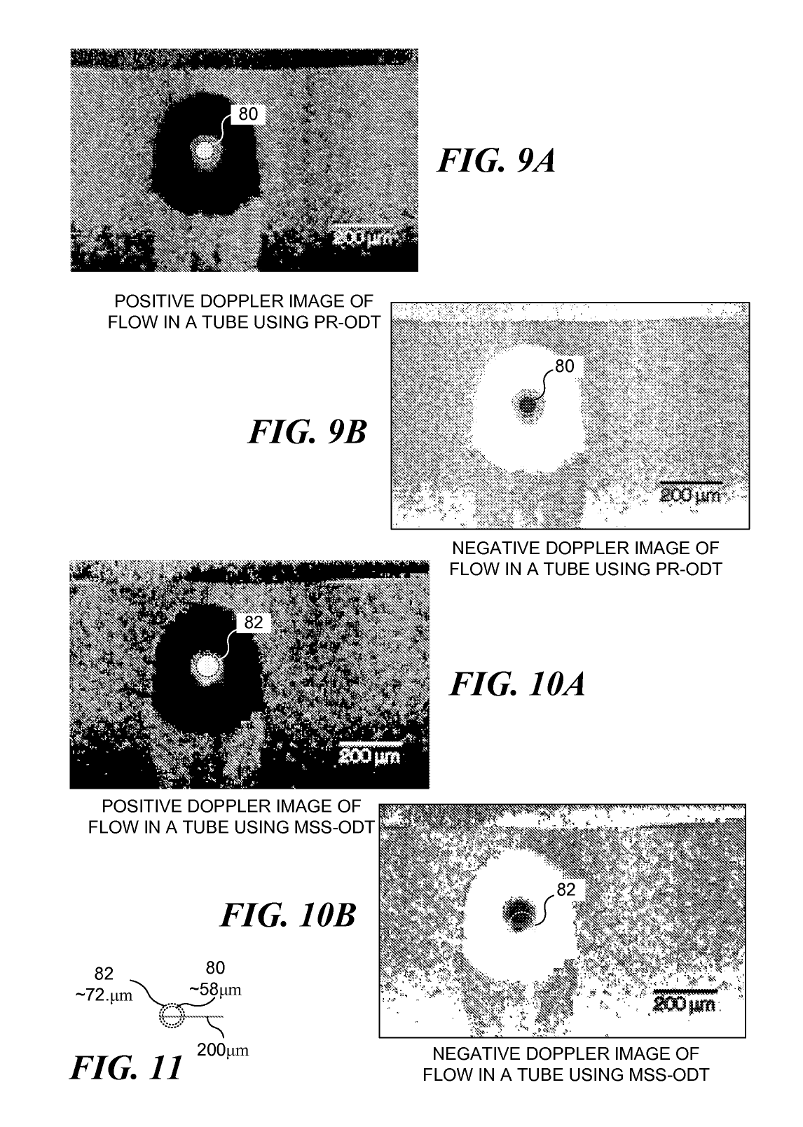

Positive and negative greyscale Doppler flow images obtained using PR-ODT are shown in FIGS. 9A and 9B, respectively. Positive and negative greyscale Doppler flow images obtained using MSS-ODT are shown in FIGS. 10A and 10B, respectively. It should be noted that original Doppler images are full color images, with color providing frequency based intensity information that cannot be readily conveyed in the greyscale images provided herein. Regardless, FIGS. 9A and 9B (PRO-ODT) each exhibit an inner tube diameter 80; whereas FIGS. 10A and 10B (MSS-ODT) each exhibit an inner tube diameter 82. FIG. 11 compares the relative sizes of diameter 80 (PR-ODT) with diameter 82 (MSS-DOT); clearly showing diameter 82 to be larger. The PR-ODT technique indicates that the inner diameter of the capillary tube is about 58 μm, while the MSS-ODT technique indicates that the inner diameter of the capillary tube is about 72 μm. As noted above, the actual inner diameter of the capillary tube is 75 μm. Thus, the larger diameter determined using MSS-ODT more accurately corresponds to the actual capillary tube inner diameter. The PR-ODT technique exhibited an error of about 29%, whereas the MSS-ODT technique exhibited an error of only about 4%. For each of FIGS. 9A, 9B, 10A, and 10B, the image illustrated therein represents a 1.16×0.75 mm (transverse×axial, without being scaled by the refractive index) field of view. The pixel size of each of these images is 492 by 320.

The clutter frequency shift ƒₛ in the phase-shifted DLF was set to be −0.2ƒᵣ for the above studies, and was empirically selected to maximize the suppression of the background Doppler signal due to clutters. The ƒₛ parameter would be changed for different experiments according to the overall clutter Doppler signal level. The flowchart of FIG. 1A can be modified to enable different values for the ƒₛ parameter to be empirically tested to determine a preferred value. For example, a plurality of different ODT images can be empirically obtained using different values for the ƒₛ parameter, and those images can be evaluated to identify which value corresponds to the highest quality ODT image.

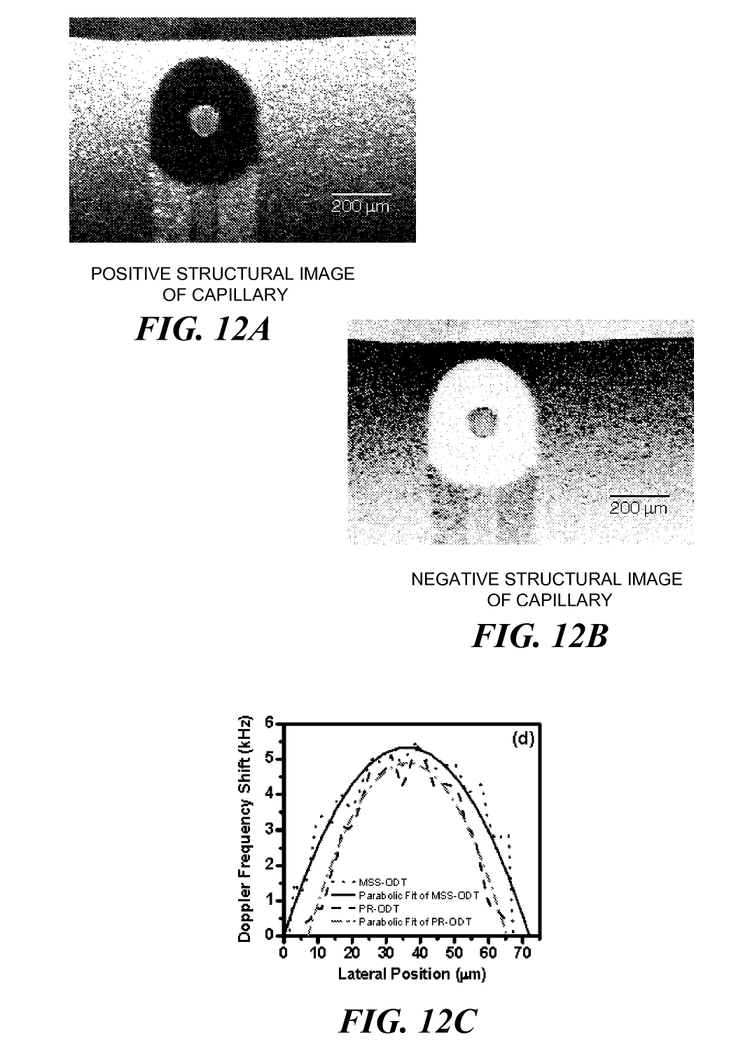

FIGS. 12A and 12B are (respectively) positive and negative structural images of the capillary tube/phantom structure. FIG. 12C graphically illustrates experimental flow profiles obtained by the two techniques (i.e., MSS-ODT and PR-ODT), and the fitted parabolic profiles, along the region corresponding to the inner diameter of the capillary tube.

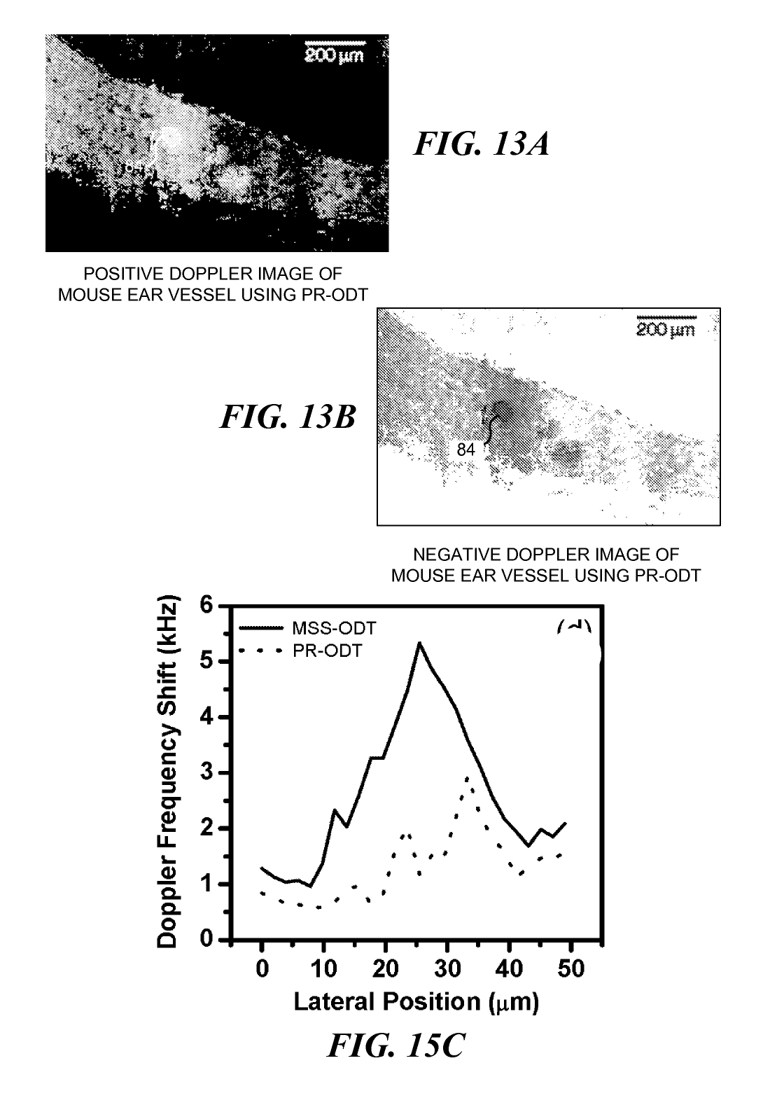

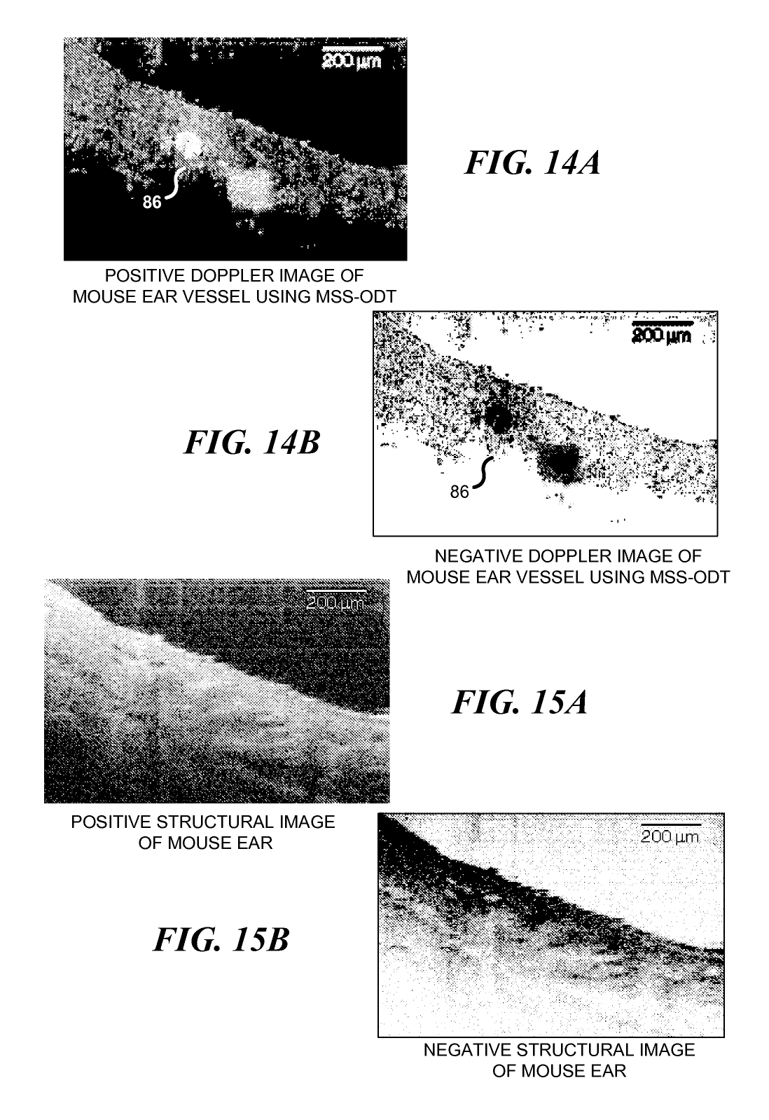

The improved performance of the MSS-ODT technique over the PR-ODT technique has further been empirically demonstrated by in vivo imaging of blood vessels in a mouse ear. In this empirical study, the mouse was first anesthetized, and then the OCT imaging beam was laterally scanned over a shaved region on the mouse ear with a handheld probe. The factor η of the phase-shifted DLF was selected to be 0.17 based on empirical analysis. Note the flowchart of FIG. 1A can be modified to enable different values for factor η to be empirically tested to determine a preferred value. For example, a plurality of different ODT images can be empirically obtained using different values for factor η, and those images can be evaluated to identify which value corresponds to the highest quality ODT image. Positive and negative greyscale Doppler flow images obtained using PR-ODT are shown in FIGS. 13A and 13B, respectively. Positive and negative greyscale Doppler flow images obtained using MSS-ODT are shown in FIGS. 14A and 14B, respectively. Again, it should be noted that original Doppler images are full color images, with color providing frequency based intensity information that cannot be readily conveyed in a greyscale image. FIGS. 15A and 15B are (respectively) positive and negative structural images of the mouse ear. Each image represents a 1.16×0.75 mm (transverse×axial, without being scaled by the refractive index) field of view. The pixel size of the images is 492 by 320. Significantly, FIGS. 13A and 13B (PR-ODT) each indicate smaller blood vessels than are indicated in FIGS. 14A and 14B (MSS-ODT).

The empirical mouse ear data indicate that vessel size is underestimated by PR-ODT by about 30%, as compared to the vessel size estimated by MSS-ODT. This quantitative comparison result is very similar to the finding in the control phantom studies where MSS-ODT was proved to be more accurate (4% error verses 29% error), suggesting that MSS-ODT provides more accurate estimation of vessel size in vivo as well. This result once again demonstrates that MSS-ODT can achieve better accuracy in estimating blood vessel diameter than PR-ODT. This increase in accuracy is due to the inclusion of the DLF (an implementation of a clutter rejection filter), which suppresses signals from stationary scatterers near the wall of blood vessels. Further, the Doppler images obtained by MSS-ODT exhibit fewer background artifacts induced by the relative motion of stationary scatterers with respect to the scanning probe. FIG. 15C graphically illustrates experimental flow profiles obtained using the two techniques (MSS-ODT and PR-ODT) about region 84 and 86 in FIGS. 13A, 13B, 14A, and 14B.

While the clutter rejection filters disclosed herein have emphasized the use of a delay line filter, those of ordinary skill in the art will readily recognize that delay line filter based clutter rejection filters are intended to be exemplary, and not limiting. Other signal filtering techniques that can selectively remove clutter from an ODT signal (i.e., an OCT signal that can be processed to yield an ODT image) can also be employed. The flowchart of FIG. 1A can be used to evaluate parameters that can be selectively removed from an ODT signal, to improve the ODT image obtained from the filtered signal. As noted above, frequency represents an exemplary, but not limiting, parameter that can be used to selectively remove clutter.

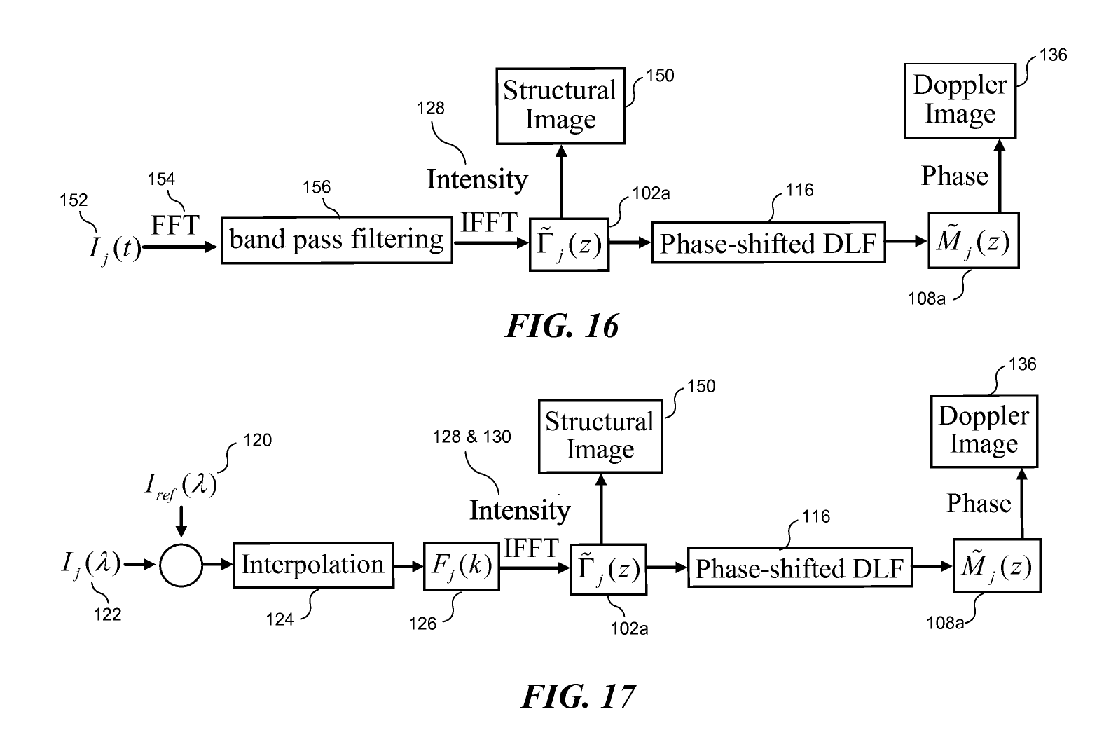

It should be recognized that clutter rejection filters can be implemented in both the time and Fourier domains (noting the MSS-ODT technique disclosed herein encompasses either approach). An exemplary time domain signal process used to remove clutter from an ODT signal is schematically illustrated in the diagram of FIG. 16, while an exemplary spectral domain signal process for removing clutter from an ODT signal is schematically illustrated in the diagram of FIG. 17.

Referring to FIG. 16, it should be noted that the functional block diagram of FIG. 16 is generally consistent with the detailed description of time domain clutter rejection filtering provided above. The functional block diagram of FIG. 16 relates to computing structural and Doppler flow images from time fringe intensity profiles 152 (Iⱼ(t)). A Fast Fourier Transform 154 is executed on each profile 152, followed by a band pass filtering operation 156. The filtered result is then processed using inverse Fourier transform 128′, to yield a signal 102a (the depth (z)-dependent complex analytic signal \tilde{Γ}ⱼ(z) for the jth axial scan, which is equivalent to the analytic signal in time-domain OCT). Structural image 150 can be produced by taking the magnitude of signal 102a (\tilde{Γ}ⱼ(z)) for all A-lines within a frame. Doppler image 136 is obtained by employing phase-shifted DLF 116 (see FIG. 5), and computing the Doppler frequency shift from an output parameter 108a (\tilde{M}ⱼ(z)), which is defined as the difference between two adjacent A-line profiles (i.e., see Eq. (1)).

Referring to FIG. 17, it should be noted that the functional block diagram of FIG. 17 is generally consistent with the detailed description of spectral domain clutter rejection filtering provided above. The functional block diagram of FIG. 17 relates to computing structural and Doppler flow images from spectral fringe intensity profiles 122 (Iⱼ(λ)). For each A-line, spectrum intensity 120 from the reference arm I_{ref}(λ) obtained before imaging is first subtracted from spectral interference fringe profile 122 (Iⱼ(λ)) to remove the DC component (this process was generally described above with respect to FIG. 8). The result is converted from a wavelength (λ) domain to a wave-number (or spatial frequency k) domain using standard spline interpolation algorithm 124, to yield spectrum 126 (Fⱼ(k)), with uniform spacing in k. Signal 102a (the depth (z)-dependent complex analytic signal \tilde{Γ}ⱼ(z) for the jth axial scan, which is equivalent to the analytic signal in time-domain OCT), is obtained by taking inverse Fourier transform 128 of Fⱼ(k) and then removing the redundant mirror signal for z<0 (as indicated by block 130; see FIG. 8). Structural image 150 can be produced by taking the magnitude of signal 102a (\tilde{Γ}ⱼ(z)) for all A-lines within a frame. Conventional PR-ODT can also be used to compute Doppler frequency shift directly from \tilde{Γ}ⱼ(z). The technique shown in FIG. 17 differs from conventional PR-ODT, by employing phase-shifted DLF 116 (see FIG. 5), and computing the Doppler frequency shift from an output parameter 108a (\tilde{M}ⱼ(z)), which is defined as the difference between two adjacent A-line profiles (i.e., see Eq. (1)), to obtain Doppler image 136.

In summary, the concepts disclosed herein encompass clutter rejection filters for Doppler OCT imaging. In one exemplary embodiment, a phase-shifted DLF is employed as a clutter rejection filter, to achieve a MSS-ODT system that separates out stationary scatterers from moving scatterers, to improve the accuracy and sensitivity of Doppler flow imaging. It is expected that these MSS-ODT techniques can be beneficially employed for imaging depth-resolved blood flow rates in the human retina.

It should be recognized that attempts to filter out clutter might unintentionally also remove some of the signal components of interest (e.g., the signal component corresponding to the moving scatterers). While such degradation of the signal component of interest is generally undesirable, it must be recognized that removing the clutter signal component, even with some corresponding degradation of the signal component of interest, may still yield a desirable improved result. The phrase “without substantially affecting the moving scatterer signal component” as used herein is intended to refer to this issue and should be understood to encompass any clutter removal process that impairs or degrades the signal component of interest, yet still achieves a desirable improvement in ODT imaging performance.

Furthermore, it should be recognized that clutter rejection filters may not remove the entire clutter signal component, yet still achieve an improvement in ODT imaging performance. The term “substantially remove the clutter signal component” is thus further intended to encompass any clutter removal process that removes at least some of the clutter signal component and thereby provides a recognizable improvement in ODT imaging performance.

Although the concepts disclosed herein have been described in connection with exemplary methods for practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for removing clutter from an optical Doppler tomography (ODT) signal, where the ODT signal comprises at least a clutter signal component and a moving scatterer signal component, the moving scatterer signal component being of primary interest, the method comprising the steps of:
(a) providing a filter configured to substantially remove the clutter signal component from the ODT signal without substantially affecting the moving scatterer signal component;
(b) obtaining an ODT signal; and
(c) using the filter to substantially remove the clutter signal component.

2. The method of claim 1, wherein the step of providing a filter configured to substantially remove the clutter signal component from the ODT signal without substantially affecting the moving scatterer signal component comprises the step of:
(a) defining at least one parameter that can be used to differentiate the clutter signal component from the moving scatterer signal component; and
(b) using the at least one parameter to generate the filter.

3. The method of claim 2, further comprising the steps of:
(a) generating a first ODT image from the ODT signal before filtering the ODT signal;
(b) generating a second ODT image from the ODT signal after filtering the ODT signal; and
(c) determining if the second ODT image represents an improvement over the first ODT image.

4. The method of claim 3, wherein if the filter does not result in improved image quality, repeating the steps of claim 2 to generate a different filter.

5. The method of claim 2, wherein the step of defining at least one parameter that can be used to differentiate the clutter signal component from the moving scatterer signal component comprises the steps of:
(a) obtaining a background ODT signal from a location where the ODT signal comprises a relatively large signal component corresponding to background noise, and a relatively small signal component corresponding to moving scatterers;
(b) analyzing the background ODT signal to determine a frequency of the relatively large signal component corresponding to background noise; and
(c) using the frequency of the background noise as the defined parameter.

6. The method of claim 1, wherein the clutter signal component arises at least in part due to stationary scatterers.

7. The method of claim 6, wherein the stationary scatterers comprise tissue forming a blood vessel wall.

8. The method of claim 1, wherein the moving scatterer signal component arises at least in part due to blood cells flowing in a blood vessel.

9. The method of claim 1, wherein the filter comprises a delay line filter (DLF).

10. The method of claim 9, wherein the DLF is phase-shifted.

11. The method of claim 1, wherein the filter is defined in regard to the time domain.

12. The method of claim 11, wherein the filter comprises a band pass filter and a phase-shifted delay line filter.

13. The method of claim 1, wherein the filter is defined in regard to the frequency domain.

14. The method of claim 13, wherein the filter includes an interpolation function and a phase-shifted delay line filter function.

15. A memory medium having machine instructions for carrying out step (c) of claim 1.

16. The method of claim 1, wherein step (c) is implemented using a hardware circuit.

17. An optical Doppler tomography (ODT) system, comprising:
(a) an optical coherence tomography system configured to generate an ODT signal, where the ODT signal comprises a clutter signal component and a moving scatterer signal component, the moving scatterer signal component being of primary interest; and
(b) a filter configured to process the ODT signal to remove the clutter signal component, producing a filtered ODT signal.

18. The system of claim 17, wherein the filter comprises a custom hardware circuit.

19. The system of claim 17, wherein the filter is implemented by processing machine instructions with a processor.

20. The system of claim 17, wherein the filter comprises a delay line filter.

21. The system of claim 17, wherein the filter is defined in regard to the time domain.

22. The system of claim 21, wherein the filter comprises a band pass filter and a phase-shifted delay line filter.

23. The system of claim 17, wherein the filter is defined in regard to the spectral domain.

24. The system of claim 23, wherein the filter provides an interpolation function and a phase-shifted delay line filter function.
